(19) United States
(12) Patent Application Publication
(10) Pub. No.: US 2010/0101656 A1
(43) Pub. Date: Apr. 29, 2010

(54) Method and device for preventing fast changes of the internal pressure in an enclosed room

(76) Inventors: Qinghua Zheng, Kassel (DE); Florian Dignath, Muenchen (DE)

Correspondence Address: MICHAEL J. STRIKER, 103 EAST NECK ROAD, HUNTINGTON, NY, 11743, US

(21) Appl. No.: 12/593,017

(22) PCT Filed: Mar. 20, 2008
(86) PCT No.: PCT/DE08/00464

§ 371 Date: Sep. 25, 2009

(51) Int. Cl. G05D 16/00

(52) U.S. Cl. 137/14; 137/102

(57) ABSTRACT

The invention relates to a method and a device for preventing fast changes of the atmospheric pressure in an enclosed room (1) induced by an external environment. According to the invention, the internal pressure in the room (1) is monitored by a sensor (3). Fast changes of the internal pressure are at least partially compensated for by the targeted supply or removal of air. The supply and removal of air preferably occurs with overpressure and underpressure containers (5, 6).

The present invention relates to a method according to the preamble of claim 1, and to a device according to the preamble of claim 7.

In enclosed passenger compartments of various vehicles which can reach high maximum speeds, such as railway trains, magnetic levitation trains, and aircraft, undesired pressure changes may occur during operation. In the case of railway trains and magnetic levitation trains, this may be caused, e.g., by traveling rapidly through narrow tunnels, or by trains passing one another on nearby tracks, in which cases pressure waves are produced. Since pressure changes of this type are perceived by passengers at a certain minimum rate of pressure change as uncomfortable pressure in the ears, the International Union of Railways, UIC, instituted guidelines (UIC 660) that define comfort levels for pressure changes of this type. Similar problems arise in aircraft if flight altitudes change rapidly, since air pressure changes with altitude.

To prevent this problem, it is known in the case of railways, in particular high speed trains, to design the passenger compartments to be as pressure-tight as possible, in order to limit the rate of pressure changes in the interior spaces that occur due to changes in the external pressure to such an extent that the pressure changes are not perceived by the passengers as being uncomfortable. However, to create the level of pressure-tightness required, it is necessary to equip all doors, windows, passages between passenger cars, etc., with seals, to equip air conditioning units or the like with the closeable valves which are used to supply or remove air, and which are closed when a tunnel is entered and are then reopened when the tunnel is exited, and to design the structure of the passenger car to have as few openings as possible. The same applies for magnetic levitation trains. Another possibility for preventing uncomfortable pressure changes from occurring is to select the ratio of the tunnel cross section to the vehicle cross section to be sufficiently large, and to permit trains to pass one another only if the tracks are sufficiently far apart, or to avoid passing in tunnels altogether, in order to reduce the size of the pressure waves.

In the case of aircraft construction, air pressure in the passenger compartments is regulated using powerful ventilators which are installed at the air inlets and outlets. Controls of this type are designed to provide continual pressure equalization, and they would require disproportionately large ventilators to handle very rapid pressure changes of the type, e.g., that occur when a train passes through a tunnel; said ventilators would also need to be able to react to rapid changes in external pressure in a highly dynamic manner.

Therefore, the technical problem of the present invention is to design the method and devices described initially in such a manner that internal pressure changes that occur rapidly in particular are easily prevented, to ensure that persons situated in the enclosed spaces do not experience discomfort.

This problem is solved according to the present invention by the characterizing features of claims 1 and 7.

The present invention is based on the idea of at least partially compensating for a pressure change—in the form of an underpressure—, which was induced in an enclosed space via an external source, by supplying a corresponding quantity of air into the space. In an analogous manner, a corresponding quantity of air is removed from the space when an overpressure suddenly occurs. In particular, the internal pressure is regulated in such a manner that the pressure is changed at a preselected rate. As a result, it is possible to protect the persons situated in the space from unpleasant pressure changes that impair riding comfort. According to a particularly preferred embodiment of the present invention, air is supplied or removed using a pressurized container or a vacuum container, thereby eliminating the use of complex fans, pumps, or the like.

Further advantageous features of the present invention result from the dependent claims.

The present invention is explained below in greater detail with reference to the attached drawings of exemplary embodiments.

FIG. 1 is a schematic depiction of an embodiment of a complete internal pressure regulator for an enclosed space;

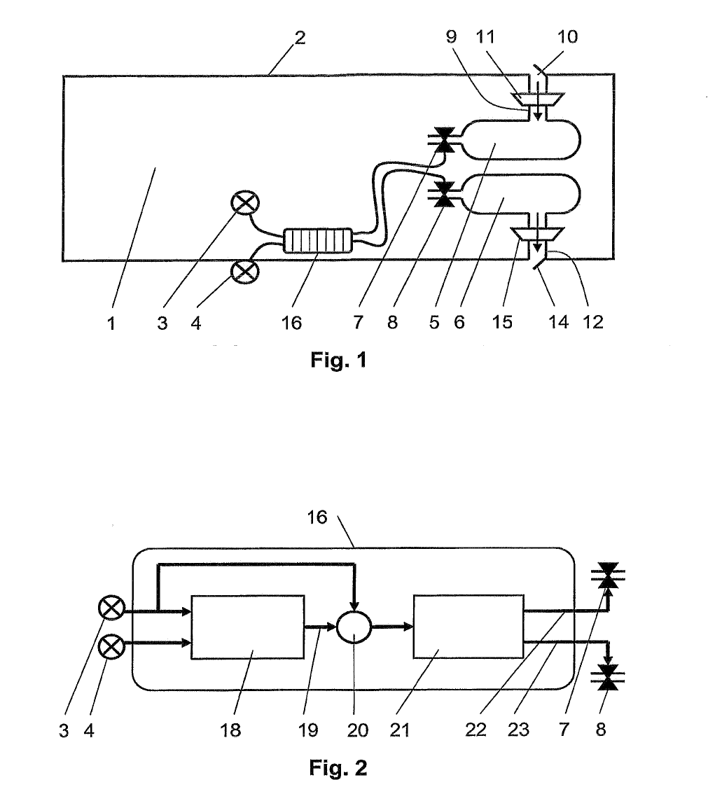

FIG. 2 shows a block diagram of a control device for an internal pressure control according to FIG. 1;

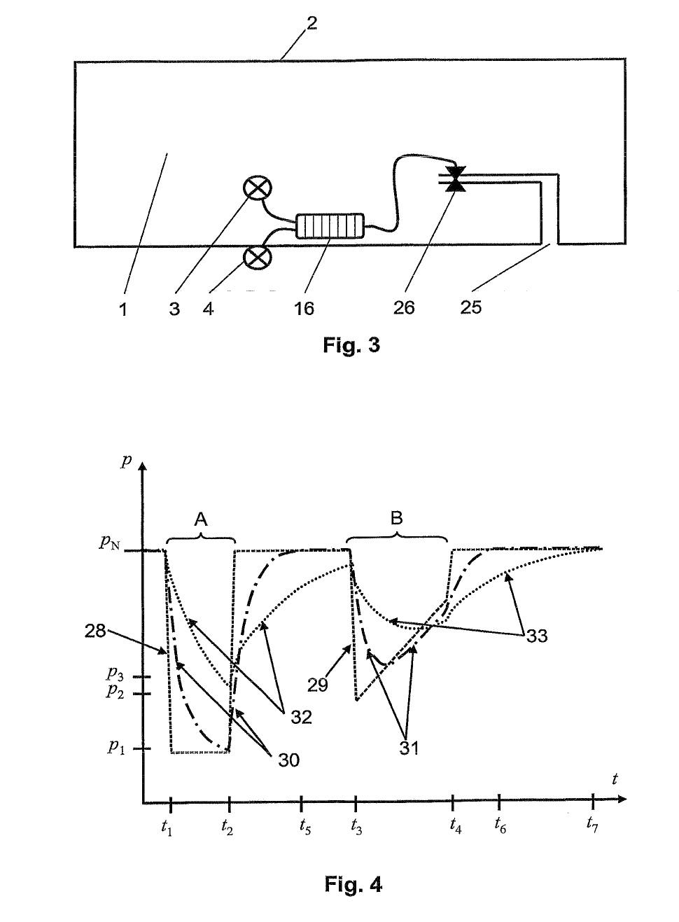

FIG. 3 is a schematic depiction of an embodiment of a partial internal pressure regulator for an enclosed space;

FIG. 4 shows, as an example, possible courses of pressure levels that occur in the passenger compartment of a railbound vehicle as it passes through a tunnel;

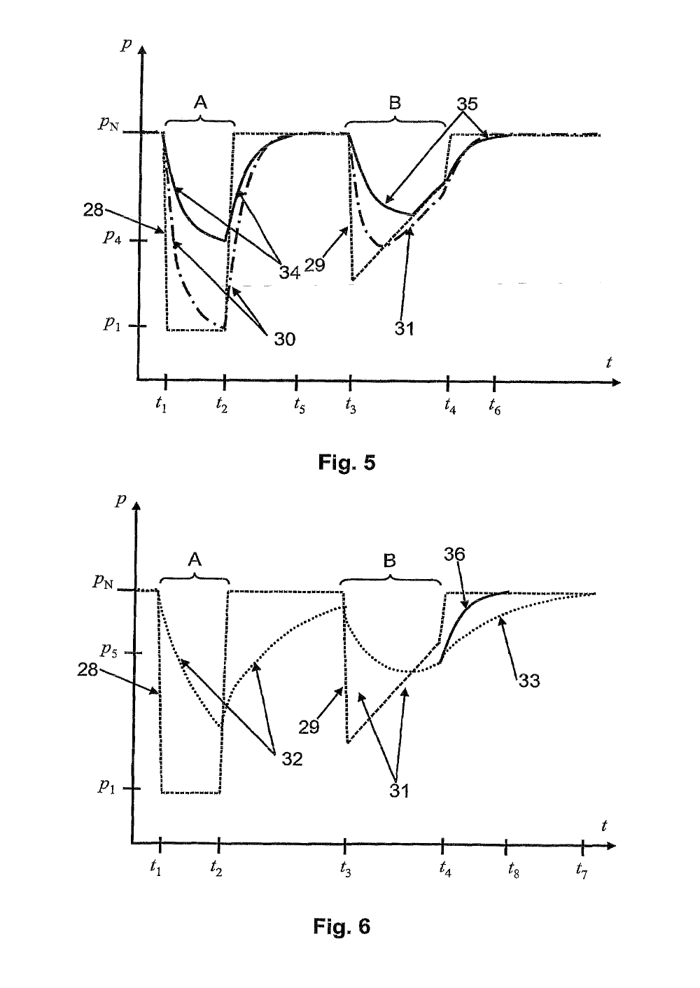

FIG. 5 shows, in a depiction similar to that shown in FIG. 4, the course of pressure in a relatively poorly sealed space while using internal pressure regulation according to the present invention; and

FIG. 6 shows, in a depiction similar to that shown in FIG. 5, the course of pressure in a relatively well sealed space while using internal pressure regulation according to the present invention.

FIG. 1 is a schematic depiction of an embodiment of the present invention which is currently considered to be the best, and which makes it possible to regulate internal pressure completely, regardless of whether the external air pressure is greater or less than the air pressure in the space under consideration. In FIG. 1, it is assumed, for example, that the air pressure in an enclosed space 1 should be regulated; enclosed space 1 is the passenger compartment of a high speed train, e.g., a magnetic levitation train, and it is enclosed by vehicle wall 2. “Enclosed” is understood to mean that vehicle wall 2 forms a housing that encloses space 1 when not-shown windows and doors are closed; the housing is sealed tight all around, except for any leaks that are typically present, and except for any ventilation openings that may be present for air conditioning units or the like. Depending on its quality, age, or other particulars, space 1 may of course be well sealed or not very well sealed, as will become clear in the description that follows.

As shown in FIG. 1, at least one pressure sensor 3 and 4 is located in space 1, and one is located outside thereof (referred to here as the “environment external to space 1”), via which the air pressure in space 1 (referred to hereinbelow as “internal pressure”) and the air pressure in the external environment (referred to hereinbelow as “external pressure”) are measured. Furthermore, at least one pressurized container 5 and one vacuum container 6 are provided, both of which may be located directly inside space 1 or outside of space 1, e.g., in an adjacent space or in a region separate from space 1, but which, like space 1, is a component of the vehicle under consideration.

Pressurized container 5 includes a control valve 7, via which compressed air may flow out of pressurized container 5 and into space 1, possibly via at least one connected line. Vacuum container 6 includes a control valve 8, via which air may flow out of space 1 and into vacuum container 6, possibly via at least one connected line. The rate at which air flows through control valves 7, 8 may be adjusted by controlling the opening cross section of control valves 7, 8, preferably with the aid of electrical signals which are transmitted to an electrical or electromagnetic actuating component of control valves 7, 8.

Furthermore, pressurized container 5 is connected via a line 9 to an opening which is formed in vehicle wall 2 and leads to the external environment; the opening may be closed in a pressure-tight manner using a flap 10 or the like. A ventilator or compressor 11 is located in line 9, using which pressure container 5 may be filled, with flap 10 open, with compressed air until a preselected overpressure is attained. Vacuum container 6 is connected via a line 12 to an opening which is formed in vehicle wall 2 and leads to the external environment; the opening may be closed in a pressure-tight manner using a flap 14 or the like. A pump 15 is located in line 12, using which vacuum container 6 may be evacuated, with flap 14 open, until a preselected underpressure is attained.

Finally, the device shown in FIG. 1 includes a regulator 16 which is connected to sensors 3, 4 and control valves 7, 8, and controls them as a function of the measured internal or external pressures such that an additional quantity of air is introduced into space 1 in a targeted manner using pressurized container 5, or an excess quantity of air is drawn out of space 1 in a targeted manner using vacuum container 1. In all, the device shown in FIG. 1 therefore operates primarily as follows:

If sensors 3 and 4 indicate that the external pressure is lower than the internal pressure, and/or that the internal pressure is dropping at an impermissibly fast rate, control valve 7 is opened and air from pressurized container 5 is released into space 1: As a result, rapid changes, of this type in particular, in the internal pressure in space 1, which would result in a decreasing internal pressure, are at least partially compensated for via the regulated supply of air, thereby making it possible to react very quickly to fluctuations in the external pressure as needed, by opening control valve 7 more or less wide. In a corresponding manner, if sensors 3 and 4 indicate that the external pressure is greater than the internal pressure, and/or that the internal pressure is increasing at an impermissibly fast rate, control valve 8 is opened more or less wide to allow air to leave space 1 and enter vacuum container 6, thereby at least partially compensating for a pressure increase in space 1. As a result, it is possible to also react very quickly to an increase in the external pressure.

When regulated normally, control valves 7, 8 will always react, depending on a specified control behavior, in the same manner to differences between the external and internal pressure in order to minimize these differences. According to the present invention, however, it is considered to be particularly advantageous to perform regulation in a manner such that the rate of the internal pressure change is at least limited to a value that matches the passengers' tolerance level. As a result, an abrupt pressure equalization that corresponds to the possible rapid fluctuations in external pressure are prevented, and it is ensured that unpleasant pressure may not act on the passengers' ears. This applies, in particular, for brief pressure fluctuations that last only a few seconds, which could not be compensated for using large, heavy ventilators, pumps, or the like.

Once pressure has been equalized as desired, control valves 7, 8 are closed, flaps 10, 14 are opened, and pressure containers 5, 6 are filled with air or evacuated using ventilators 11 or pumps 15 until a preselected overpressure or underpressure is attained. Flaps 10, 14 may then be closed. Since regulation is normally carried out only at relatively long intervals, e.g., between passages through tunnels, ventilators 11 and pumps 15 may be designed to be relatively small in size. In addition, it is only necessary to move flaps 10, 14 into an opened or closed position using electrical means or other types of means, i.e., there is no need to regulate their particular opening cross section.

Regulator 16, together with sensors 3 and 4, control valves 7 and 8, and containers 5 and 6, form a control device according to the present invention, and may basically have any design, according to FIG. 1, i.e., they may be operated, in particular, electronically, pneumatically, or in any other manner. For electronic operation, regulator 16 is designed, e.g., as shown in FIG. 2. According thereto, it contains a control unit 18 which is connected to sensors 3, 4, and to which the sensor signals and other types of information may be transmitted, e.g., information on the ground speed, the position of the vehicle, the terrain (e.g., valleys or hills on the route), or the like. Based on this information, a favorable expected value curve is generated—and which is preferably calculated in advance with reference to the known terrain—, and it is output at output 19 of control unit 19. The regulation is therefore not carried out based on a fixed expected value, but rather on an expected value that is variable over time. The expected value curve is constantly compared with the particular actual value of the internal pressure using a comparator 20, to which the output signals from sensor 3 are also directed. The difference between the two values is sent to a control component 21 which, depending on the case, outputs an actuating signal at an output 22 connected to control valve 7 or at an output 23 connected to control valve 8. Using these actuating signals, control valves 7, 8 are adjusted in a manner such that the desired pressure compensation is attained. Particularly advantageously, the expected values at output 19 are therefore time-variable guide variables which ensure that control valves 7, 8 are opened wide enough at all times to attain a preselected rate of pressure change in space 1. This means, for example, that, if the external pressure drops rapidly, control valve 7 is initially opened wide so that, due to a large quantity of air to be supplied, the internal pressure may decrease slowly. Next, control valve 7 may usually then be closed repeatedly, because the difference between the external pressure and the internal pressure becomes less and less, as does the demand for supplied air until the minimum internal pressure, which corresponds to the reduced external pressure, is reached. In particular, the time-variable target pressure curve is selected such that specified comfort criteria (e.g., UIC 660) are approximately maintained under all circumstances.

If it is assumed, with regard for the dimensions of pressurized container 5, that space 1 has a volume of 150 m³, then a pressure drop in space 1 of 1000 Pa/10 s—which is just barely permissible per UIC 660—corresponds via computation to an air mass flow rate of approximately 0.15 kg/s if an adiabatic outflow from pressure container 5 is assumed. If this air mass flow rate should be compensated for entirely from pressure container 5, it must pass through control valve 7. If pressure container 5 is filled, e.g., with air having an overpressure of 2 bar=2·105 Pa, this corresponds to an air mass flow rate of approximately 0.06 m³/s. Although the outflowing air cools by approximately by 50° C. compared to the temperature in pressure container 5, the advantage results that the air flows into the space very quickly and may therefore be effective even in the case of pressure changes that last only a few seconds or longer. Similar calculations may be carried out for the case in which vacuum container 6 is required to rapidly compensate for pressure spikes. The calculations also show that, under the given circumstances, the volume of pressure container 5, 6 typically must not be greater than, e.g., one percent of the volume of space 1.

The device shown in FIG. 1 makes it possible to actively regulate the internal pressure in space 1 at any time in the presence of elevated external pressures or reduced external pressures. Cases may also exist, however, that only result in an increase or a reduction in internal pressure. In cases such as these, pressurized container 5 or vacuum container 6 and the associated components may be eliminated. A case of this type may occur, e.g., when space 1 is sealed very well and, therefore, e.g., a reduction in the external pressure due to passage through a tunnel only results in a slower and, in particular, permissible rate of pressure change in space 1. However, if the vehicle and, with it, well sealed space 1—once the internal pressure of which has been reduced—must then stop at a station located directly after the tunnel, or at a station located in tunnel 1, which is situated in normal external pressure, then pressure may only increase gradually to the higher external pressure, if no special measures are taken. As a result, it may be necessary to keep the vehicle doors closed for a considerable period of time (e.g., 30 s) until the pressure has equalized, in order to protect the passengers from a pressure shock.

According to the present invention, in a case such as this, the pressure equalization may be accelerated with the aid of the device shown in FIG. 1, or with the aid of a device of the type shown in FIG. 3, in which the same components are labeled with the same reference numerals as in FIG. 1. In contrast to FIG. 1, vehicle wall 2 in this case only includes one opening 25 which leads to the external environment, and which may be opened more or less wide using control valve 26. A control device of the type shown in FIGS. 1 and 2 may be used to regulate the position of control valve 26.

When the device shown in FIG. 3 is used, sensors 3 and 4 indicate a relatively large pressure difference at the end of the tunnel or in an underground train station. As a result, regulator 16 opens control valve 26 in a manner such that the pressure between the outside and the inside equalizes in compliance with the UIC criteria, but it does so at a rate of pressure change that is much greater than would result if space 1, which is assumed to be tight, were left alone. In this manner, the waiting period until the vehicle doors are opened may be reduced considerably, e.g., to a few seconds, and this is basically unnoticeable to the passengers.

FIGS. 4 through 6 show, as examples, a few possible graphs of pressure curves, in which time is plotted on the x-axis, and the pressure is plotted in random units on the y-axis. In addition, pN stands for the normal external pressure in the external environment, which is present, e.g., along an open route traveled by a train.

In FIG. 4, it is assumed that a train which includes a passenger car containing space 1 shown in FIG. 1 is moving along a predefined route and enters a tunnel A at time t1. It is also assumed that the external pressure therefore drops abruptly along a dashed line 28 to a relatively low value p1, which is, e.g., 3000 Pa lower than pressure pN, stays at value p1 as the train passes through the tunnel, and abruptly increases to pN at time t2 when the train exits the tunnel. It is also assumed that, at time t3, the train enters a second tunnel B in which a station is present at which the train comes to a standstill at time t4. In tunnel B, the external pressure initially drops along a dotted curve 29, e.g., only to a value p2, and then assumes normal pressure pN when the train comes to a standstill at time t4.

Furthermore, the course of the internal pressure in a poorly sealed space 1 of the train is shown in FIG. 4 as an example, using dashed curves 30 and 31. As indicated by curves 30, 31, the internal pressure tracks curves 28 and 29 relatively rapidly, i.e., pressure equalization takes place automatically and without much delay. As a result, the internal pressure has reached minimum external pressure p1 at time t2, while, shortly after the train exits tunnel A at time t5, the internal pressure has returned to normal external pressure pN. The pressure changes shown here are so rapid that they are uncomfortable to the passengers. However, the result of space 1 not being tight is that, after the train stops at station B at time t4, the internal pressure returns relatively quickly to normal pressure pN, reaching it at approximately at time t6, and so the vehicle doors may be easily opened at time t6.

Finally, FIG. 4 shows, as an example, the course of the internal pressure in space 1 that is sealed relatively well, using dotted curves 32 and 33. As a result, while passing through tunnel A, the internal pressure drops relatively slowly, to point p3, and after tunnel A is exited, the internal pressure increases relatively slowly, until value pN is reached. The same applies for the passage through second tunnel B starting at time t3. As a result of the good sealing of space 1, however, the internal pressure remains below normal external pressure pN for a relatively long period of time once the train has come to a standstill at time t4, as indicated by dotted curve 33; external pressure pN is finally reached at time t7. In this case, the vehicle doors must not be opened at time t4 or at time t6, since there is a risk that the passengers will experience a pressure shock at these instants. It is important to wait until the internal pressure has come sufficiently close to external pressure pN, approximately at time t7.

FIG. 5 shows the pressure curves that occur when the internal pressure regulation according to the present invention and described with reference to FIG. 1 is used, in the case of a poorly sealed space 1. The same conditions are assumed for the external pressure and the self-adjusting internal pressure as were assumed for FIG. 4 (curves 28, 29 and 30, 31). However, if, upon entry into tunnel A, the regulation procedure described above takes place, according to the present invention, as soon as the external pressure is sufficiently lower than the internal pressure, then control valve 7 is initially opened, and air is leaves pressure container 5 and enters space 1 so rapidly that the internal pressure drops gradually along a solid curve 34 shown in FIG. 5, until it reaches value p4. Preferably, the regulation takes place in this range, as described above, in such a manner that the rate of pressure change indicated via the slope of curve 34 never exceeds the passengers' tolerance levels. After tunnel A is exited, control valve 7 may be closed and control valve 8 may be opened, so that air flow out of space 1 and into vacuum container 6 for a period of time, thereby preventing an abrupt increase in the internal pressure to value pN. Advantageously, the regulation is also carried out in this case with consideration for the comfort levels.

Similar pressure curves may be realized in the region of tunnel B, as indicated by solid curve 35 in FIG. 5.

Finally, FIG. 6 shows the influence of a device shown in FIG. 3 on the course of pressure in a well sealed space 1; the same conditions exist in the region of tunnel A as shown in FIG. 4 (curves 28, 29 and 32, 33). Since the comfort level is not exceeded here, in the region of tunnel A, internal pressure regulation is not required.

In contrast, internal pressure regulation in tunnel B is advantageous in this case, using the device shown in FIG. 3. As shown via curve 33, no special measures are required up to approximately time t4. However, at time t4, the internal pressure, having value p5, is much lower than external pressure pN in station B and when the vehicle is at a standstill. Therefore, according to the present invention, control valve 26 shown in FIG. 3 is opened, thereby allowing pressure to equalize rapidly via opening 25 in vehicle wall 2. According to the present invention, although the regulation is also used in this case to control the opening state of control valve 26 in such a manner that the rate of pressure change does not exceed the comfort limit, the increase in internal pressure tracks, e.g., a solid curve 36 shown in FIG. 6. However, the rate of pressure change is selected in this case such that the required pressure equalization is completed at approximately time t8, which is much closer to time t4 (when the vehicle is stopped in station B) than is time t7. The vehicle doors may therefore be opened at time t8 without the passengers experiencing uncomfortable pressure on their ears.

As shown in FIGS. 4 through 6, the distances between tunnels A and B are relatively great under normal circumstances. As a result, it is possible to gradually recharge pressure containers 5 and 6 with compressed air or to evacuate them to the desired level of underpressure between two regulation events. It is also shown that the control device according to FIG. 1 in particular may also be used in cases in which brief or minor leaks are present in space 1. By using the device shown in FIG. 1, it is also possible to tolerate a gradual drop in pressure tightness of the vehicles, within certain limits, as may occur, e.g., over the service life of the vehicles.

The use of the methods and devices according to the present invention is not limited to enclosed spaces of vehicles. Similar problems may also result in conjunction with stationary spaces, e.g., in laboratories used for biological or chemical purposes. It is not typically necessary in these cases to prevent rapid pressure changes of this type that would be perceived as uncomfortable by the individuals working in the laboratories. Instead, it must often be ensured that opening a door or a window briefly—regardless of whether an airlock or the like is present—must not result in air contaminated with harmful substances such as bacteria or viruses escaping to the outside from the space, or entering the space from the outside. Using the device shown in FIG. 1, it would be possible, even when a door or a window is opened briefly, to ensure via the use of a pressurized container or a vacuum container that a preselected pressure difference between the internal pressure and the external pressure is not exceeded. A main advantage that is attained via the present invention also exists in this case, namely that there is no need to provide oversized and, therefore, complex pumps, fans, or the like, merely to safely maintain a preselected overpressure or underpressure in the space only for the brief period of time when a door or the like is opened. As in the case of space 1 in a vehicle, the advantage also results that pressure container 5, 6 may be made effective very rapidly and no longer require long start-up times, as is the case for a pump or the like.

The present invention is not limited to the embodiments described, which could be modified in various manners. This applies, in particular, to the size and number of pressure containers 5 and 6 provided per space 1. In the case of large spaces in particular, it may be advantageous to provide several containers 5 and/or 6, in order to evacuate air or draw it in at various points. Furthermore, it is possible to use as the openings provided in the walls of the space and which lead to the external environment (e.g., 25 in FIG. 3) those openings that are already present in spaces containing air conditioning units, and to possibly equip these openings with control valves. It is also advantageous to close any other openings that may be present during the times in which the control device described is operating. It is clear that, depending on the case, only one internal pressure sensor 3 is required, even if the additional use of an external pressure sensor 4 is advantageous in many cases, e.g., during the above-described stops in underground stations. Vehicles that continually travel along the same path may also be outfitted with target pressure curves for the control device that are modified especially for this route and that may have been calculated based on experiential values. In addition, the control device, which is composed of sensors 3 (and, possibly, 4), control valves 7, 8 or 26, containers 5, 6, and regulators 16 may basically be realized in many different manners in terms of hardware and software. Finally, it is understood that the features described may also be used in combinations other than those described and depicted herein.

What is claimed is:

1. A method for preventing rapid changes in the atmospheric pressure in an enclosed space (1) induced by an external environment,
wherein
the internal pressure in the space (1), at the least, is monitored, and rapid changes in the internal pressure are at least partially compensated for via the controlled supply or removal of air.

2. The method as recited in claim 1,
wherein
the supply or removal of air is regulated in a manner such that a preselected rate of pressure change is maintained in the space (1).

3. The method as recited in claim 1,
wherein
the regulation is carried out using a preselected target pressure curve for the internal pressure.

4. The method as recited in claim 1,
wherein
the regulation is carried out with consideration for predefined comfort criteria.

5. The method as recited in claim 1,
wherein
air is supplied or removed using at least one pressurized container or a vacuum container (5, 6).

6. The method as recited in claim 1,
wherein
air is supplied using at least one control valve (7, 8, 26) which leads to the external environment.

7. A device for preventing rapid changes in the atmospheric pressure in an enclosed space (1) induced by an external environment,
wherein
it includes at least one pressure sensor (3) located in the space (1), a means for supplying or removing air, and a control device which includes the pressure sensor (3) and the means, and which is used to at least partially compensate for the rapid pressure changes.

8. The device as recited in claim 7,
wherein
the means includes a pressurized container and/or vacuum container (5, 6) for air, which include(s) a control valve (7, 8), and the control device is designed to regulate the position of the control valve (7, 8).

9. The device as recited in claim 7,
wherein
the means includes at least one control valve (26) which leads to the external environment, and the control device is designed to regulate the position of the control valve (26).

10. The device as recited in claim 7,
wherein
the control device includes a pressure sensor (4) for measuring the air pressure in the external environment.

11. The device as recited in claim 8,
wherein
a time-variable guide variable which is adapted to a preselected target pressure curve is assigned to the control device.

12. The device as recited in claim 11,
wherein
the target pressure curve is plotted with consideration for predefined comfort criteria.

13. The device as recited in claim 7,
wherein
it is designed to regulate the rate of pressure change in a railbound vehicle, in particular a magnetic levitation vehicle.

14. The device as recited in claim 13,
wherein
it is used to regulate the rate of pressure change in a well-sealed space (1) of the vehicle using at least one control valve (26) which leads to the external environment.
